(19) United States
(12) Patent Application Publication
(10) Pub. No.: US 2006/0147666 A1
(43) Pub. Date: Jul. 6, 2006

(54) Production of a polyester hollow body or its preform with a reduced acetaldehyde content

(76) Inventors: Andreas Christel, Zuzwil (CH); Brent Allan Culbert, Wil (CH); Theodor Jurgens, Casstrop-Rauxel (DE)

Correspondence Address: CARELLA, BYRNE, BAIN, GILFILLAN, CECCHI,;STEWART & OLSTEIN, 5 BECKER FARM ROAD, ROSELAND, NJ, 07068, US

(21) Appl. No.: 10/537,459

(22) PCT Filed: Oct. 22, 2003
(86) PCT No.: PCT/CH03/00686

§ 371 Date: Nov. 30, 2005

(30) Foreign Application Priority Data
Dec. 18, 2002 (DE) 10259694.8

(51) Int. Cl. B65D 1/02; C08G 63/02

(52) U.S. Cl. 428/36.92; 528/272

(57) ABSTRACT

The invention relates to a method for producing a polyester hollow body or its preform with a reduced acetaldehyde content from a drop-shaped, globular or spherical polyester granulate with a granulate diameter of less than 2 mm. Said method is characterised in that the molecular weight of the polyester in the production step of melt-phase polymerisation is set to an intrinsic viscosity (IV) value of 0.15 to 0.4 dl/g, the melt is transferred to a drop-shaped, globular or spherical mould by drop-processing and subsequently solidifies, the molecular weight of the polyester in the production step of solid-phase polycondensation is increased to an IV value of greater than 0.65 dl/g and the polyester material that has been treated in this manner is shaped by being introduced into shaping means, to form the hollow body or its preform. The shaping process can be carried out by injection moulding, sintering or extrusion blow moulding. The invention also relates to a polyester material for the production of a polyester hollow body or its preform with a reduced acetaldehyde content, in addition to a polyester hollow body or its preform with a reduced acetaldehyde content.

The invention relates to a method for producing a polyester hollow body or its preform with reduced acetaldehyde content made of drop-shaped, ball-shaped or ball-like polyester granulate with a granulate diameter of less than 2 mm. The invention also relates to a polyester material for the production of a polyester hollow body or its preform with reduced acetaldehyde content.

### DESCRIPTION OF THE PRIOR ART

In conventional production methods of a polyester bottle granulate, the polymerisation occurs in the melt phase up to an IV value of more than 0.4 dl/g, typically of approximately 0.6 dl/g. Thereafter the polymer melt is solidified and molded into particles (granulates) which are mostly uniform, whereby the molding and solidification can also occur simultaneously or in reverse sequence. Thereafter there is a solid state polycondensation in order to achieve an IV value of more than 0.7 dl/g, typically of approximately 0.8 dl/g.

Several million metric tons of polyethylene terephthalate (PET) of bottle material are currently produced, with the different types different mainly by a lower share of co-monomers.

The disadvantages of this production process are that a relatively large part of the polymerization occurs in the melt phase which in comparison with the solid state polycondensation leads to considerably higher investment costs. Moreover, degradation reactions occur in the melt phase in addition to reactions leading to an IV increase, which degradation reactions increase with increasing viscosity (i.e. with increasing IV value). The incurred damage to the polymer chain can be reversed again only partly in the subsequent solid state polycondensation process. Especially disadvantageous is the formation of vinylester groups which during the further processing, e.g. in an injection molding process, disintegrate under the formation of acetaldehyde. Degradation reactions are also disadvantageous which lead to a discoloration (yellowing) of the PET.

In order to reduce the above disadvantages it is desirable to limit the IV rise in the melt phase and to increase the IV rise in the subsequent solid state polycondensation. In the case of IV values below approximately 0.4 dl/g, considerably problems in the solidification and molding into uniform particles (granulates) will thus occur. Various patents such as by Goodyear (U.S. Pat. No. 4,165,420; U.S. Pat. No. 4,205,157) or DuPont (U.S. Pat. No. 3,405,098) describe a PET production process in which a low-molecular prepolymer with an IV value below 0.45 dl/g, typically approximately 0.3 dl/g, is produced in the melt phase and is subsequently condensed as small particles by solid state polycondensation (SSP—solid state polycondensation) to the desired IV value over 0.6 dl/g, typically over 0.7 dl/g. Processes are employed in the production of the prepolymer particles which contain the spraying of the polymer melt or the grinding of the solidified pieces.

Although these very small and partly irregular particles lead to an advantageous and thus preferably behavior within the SSP process, they are not suitable to lead to optimal results in the production of preforms. On the one hand, the handling, drying and processability is made more difficult on currently used injection molding machines and on the other hand one must expect high crystal sizes and very high crystallinity with such small particles, which as a result lead to high processing temperatures (cf. Schiavone WO 01/42334, page 4).

DuPont has described in a series of patent specifications various ways for forming (U.S. Pat. No. 5,633,018; U.S. Pat. No. 5,744,074; U.S. Pat. No. 5,730,913) and simultaneously for forming a special crystal structure (U.S. Pat. No. 8,840,868; U.S. Pat. No. 5,532,233; U.S. Pat. No. 5,510,454; U.S. Pat. No. 5,714,262; U.S. Pat. No. 5,830,982) which lead to an improved behavior in the solid state polycondensation process. The forming process requires a high amount of equipment and is expensive. The after-condensed polyester has a very high melting point, leading to high processing temperatures in the injection molding process (cf. U.S. Pat. No. 5,532,233, example 5). The high melting point is the result on the one hand of the necessary very high after-condensation temperature and on the other hand of the described crystal structure.

The connection of melting temperature and crystal size was derived by Fontaine¹ in the following way:
¹ Morphology and melting behaviour of semi-crystalline poly(ethylene terephthalate): 3 Quantification of crystal perfection and crystallinity; F. Fontaine et. al.; Polymer 1982, Vol. 23, p. 185

(1)

with I=crystal size
Tₘ=melting temperature
Tₘ=equilibrium melting temperature.

The equation shows that the melting temperature of a polymer is always lower than the equilibrium melting temperature, namely by a value which is inversely proportional to the polymer crystal size.

WO 01/42334 describes a method which optimizes the PET production in such a way that a preform (or a parison) with improved properties can be produced. An optimization concerning the particle production process has not been performed. Drop-forming is even exclusively excluded. Moreover, the process is limited to polyethylene terephthalate with a high share of copolymer, which on the one hand has a negative influence on the treatment in the SSP and on the other hand limits the scope of use of the thus produced PET.

Different methods are known according to the state of the art which transform a polyester melt by drop shaping into a drop-shaped, ball-shaped or ball like shape and thereafter solidify the same (DE 10042476; DE 19849485; DE 10019508). These methods describe the production of polyester granulate and relate to the optimization of the polyester production process. The methods do not describe the required measures which need to occur in the polyester production process and need to follow the polyester production process in order to lead to an improved hollow body or its preform.

It is the object of the present invention to provide a method which improves the production process of polyesters, and in particular polyethylene terephthalate (PET), in such a way that the aforementioned disadvantages can be excluded and hollow bodies made from the thus produced polyester, especially bottles, or their preforms, can be produced with the lowest possible content of acetaldehyde.

It is a further object of the present invention to provide a polyester material from which polyester hollow bodies, and especially bottles, or their preforms, can be produced at the lowest possible processing temperature and thus with the lowest possible content of acetaldehyde.

The declarations below show that it is important for this purpose to optimally tune with respect to each other the ratio of the IV rise in the melt and the solid state, the granulate size, optionally the development of the crystal structure in the granulating and crystallization process, the conditions of the solid state polycondensation and the processing conditions in the forming step.

### SUMMARY OF THE INVENTION

This object is achieved in the method as mentioned above in such a way that
the molecular weight of the polyester in the production step of the melt phase polymerization is set to an IV value of 0.15 to 0.4 dl/g;
the melt is transformed by drop shaping into a drop-shaped, ball-shaped or ball-like shape and is thereafter solidified;
the molecular weight of the polyester is increased in the production step of the solid state polycondensation to an IV value of larger than 0.65 dl/g, and
the thus treated polyester material is introduced for forming into a forming means in order to obtain the hollow body or its preform.

A hollow body or its preform can be obtained in this way with a considerably lower acetaldehyde content than in the previously known methods.

The polyester material thus treated can be plasticized at least partly before and/or during its forming.

According to a first embodiment of the method in accordance with the invention, the actual forming occurs by melting down and injection molding the thus treated polyester material.

According to a further preferred embodiment of the method in accordance with the invention, the forming occurs by extrusion blow molding of the thus treated polyester material.

The melting can occur by various methods. For example, by mechanical introduction of energy, heat conduction or heat irradiation, especially by means of an extrusion apparatus and/or a microwave apparatus.

The melting preferably occurs at a temperature which is 5° C. or more below a temperature T0, with T0 corresponding to the optimal processing temperature at which a similar polyester from a conventional production process can be processed.

According to another preferred embodiment of the method in accordance with the invention, the forming occurs by sintering of the thus treated polyester material, with the polyester material being introduced into a mold and being formed by sintering into a preform. The introduction of the polyester material into the mold preferably occurs by gravitational forces, by movement by means of a conveying medium and/or by inertia forces, especially by centrifugal forces.

Preferably, the polyester concerns a polyethylene terephthalate or a copolymer of polyethylene terephthalate, and the maximum temperature in the production step of solid state polycondensation is at or below 230° C., preferably at or below 225°.

Appropriately, the granulate diameter is in the region of 0.4 to 1.9 mm, preferably in the region of 0.7 to 1.6 mm.

Further preferable embodiments of the method in accordance with the invention are characterized in that the polyester concerns a copolymer of polyethylene terephthalate, with preferably
a) the diol component consists to more than 94% of ethylene glycol and the dicarboxylic acid component consists to approximately 100% of terephthalic acid, or
b) the diol component consists to more than 98% of ethylene glycol, or
c) the dicarboxylic acid component consists to more than 96% of terephthalic acid.

Preferably, the step of preheating to the after-condensation temperature in solid state polycondensation occurs in a period of 1 to 10 minutes, preferably 2 to 8 minutes.

Appropriately, the polyester is removed from the drop forming apparatus after the drop forming with the help of a discharging apparatus, with the discharging apparatus preferably concerning a fluid or fluidized bed with a perforated floor through which gas flows and one or several product discharge openings.

The method in accordance with the invention finally allows producing from the preform a hollow body with reduced acetaldehyde content, especially a bottle with reduced acetaldehyde content.

The object of the invention is also achieved by a polyester material for producing a polyester hollow body or its preforms with reduced acetaldehyde content, with the polyester material being present as a drop-shaped, ball-shaped or ball-like polyester granulate with a granulate diameter of smaller than 2 mm, characterized in that
the molecular weight of the polyester material is set in a production step of melt phase polymerisation to an IV value of 0.15 to 0.4 dl/g;
the melt is transformed by drop shaping into a drop-shaped, ball-shaped or ball-like shape and is thereafter solidified;
the molecular weight of the solidified polyester material is increased in the production step of the solid state polycondensation to an IV value of larger than 0.65 dl/g, and
the polyester material is meltable for its forming and can be introduced into a forming means in order to obtain the polyester hollow body or its preform.

This polyester material allows obtaining a hollow body or its preform with considerably lower acetaldehyde content than with previously know polyester materials.

It has proven to be especially advantageous that the melting can occur at a temperature which is 5° C. or more below a temperature T0, with T0 corresponding to the optimal processing temperature at which a similar polyester from a conventional production process can be processed.

The polyester material especially concerns a polyethylene terephthalate or a copolymer of polyethylene terephthalate, with the maximum temperature in the production step of solid state polycondensation being at or below 230° C., preferably at or below 225°.

It is especially advantageous in respect of the polyester material if the granulate diameter is in the region of 0.4 to 1.9 mm, preferably in the region of 0.7 to 1.6 mm.

The step of preheating the polyester material to the after-condensation temperature in solid state polycondensation appropriately occurs in a period of 1 to 10 minutes, preferably in a period of 2 to 8 minutes.

Further advantages, features and possible applications for the invention are obtained from the following description of various partial aspects of the invention which shall not be understood as being limiting in any way.

Polyester

The polyester concerns a polymer which is obtained by polycondensation from its monomers, a diol component and a dicarboxylic acid component. Whereas different, mostly linear or cyclic diol components can be used, the use of predominantly ethylene glycol is preferable. Similarly, various mostly aromatic dicarboxylic acid components can be used, with the use of predominantly terephthalic acid being preferable.

Instead of dicarboxylic acid it is also possible to use its respective dimethyl ester.

In an embodiment of a sub-claim, the polyester consists of a copolymer of polyethylene terephthalate, with either:
the diol component consisting to more than 94% of ethylene glycol and the dicarboxylic acid component consisting to approximately 100% of terephthalic acid, or
the diol component consisting to more than 98% of ethylene glycol, or o the dicarboxylic acid component consisting to more than 96% of terephthalic acid.
   Liquid Phase Polymerization

The polyester monomers are polymerized or polycondensed in a first step in liquid phase in order to achieve an IV value of 0.15 to 0.4 dl/g. A value of between 0.20 and 0.35 dl/g is preferred. The process usually occurs at an increased temperature in vacuum for removing the low-molecular polycondensation cleavage products, but can also occur under atmospheric pressure or increased pressure when low-molecular polycondensation cleavage products are removed by means of an inert carrier gas for example. In addition to the monomers, additives can be added in the liquid phase polymerization, e.g. catalysts, stabilizers, dyeing additives, reactive chain extension additives, etc.

The formation of degradation products, which also especially includes acetaldehyde, is minimized by the limitation of the IV rise in the melt phase to a value below 0.4 dl/g.

Drop Forming

After the liquid phase polymerization, the polyester melt is brought by drop forming into a drop-shaped, ball-shaped or ball-like form and thereafter solidified. Solid particles (granulates) are produced in this process with a granulate diameter of smaller than 2 mm, typically between 0.4 and 1.9 mm, preferably between 0.7 to 1.6 mm, with the ideal size being derived according to the requirements of the solid state polycondensation.

A method for forming polyester granulates by drop forming has been described in the patent DE 10042476 which is hereby included in the present invention.

Usually, the drop forming is achieved by means of a drop forming die, with the drop forming occurring in a chamber filled with gas. The gas can concern air or an inert gas such as nitrogen. The gas can also contain other gaseous, liquid or solid components, which may concern polycondensation cleavage products, additives, mists of liquid coolant media or dusts for nucleation or for preventing gluing.

It is advantageous to support the drop forming by vibration excitation in order to prevent the formation of strings. The vibration excitation can be exerted either on the polyester melt or at least on a part of the drop forming equipment, especially the die. A plurality of still liquid polyester particles is formed.

Prior to the solidification of the polyester particles, a sufficient amount of time must be provided so that drop-shaped, ball-shaped or ball-like particles will form. This usually occurs in a first part of a falling section and is usually completed within less than 3 seconds, typically within less than one second.

For the purpose of solidifying the polyester particles it is necessary to cool the same, which usually starts in a first part of a falling section and is continued or completed in a second part of a falling section. At the end of the falling section the polyester particles can be further cooled in a cooling medium or a cooling surface, especially a cooling liquid. In order to ensure the uniformity of the particles, they may only impinge upon a cooling surface when they are substantially dimensionally stable and the crystal structure on the contact surface does not change departing from the remainder of the particle.

Preferably, a gas stream is maintained in the falling path. One or several gas streams can be concerned which differ with respect to their direction of flow, speed of flow, temperature and composition.

At the same time with the cooling for solidification of the polyester melt there can be a partial crystallization which depending on the conduction of the process can also be limited to the particle surface only.

The cooling and solidification shall proceed in such a way that no crystal structure is obtained with excessively large crystallites which would require high processing temperatures in subsequent melting, with the average crystallite size being less than 9 nm, preferably smaller than 8 nm, measured according to the method as described in U.S. Pat. No. 5,510,454.

At the end of the falling section there is a discharge apparatus with which the polyester particles are removed from the drop forming apparatus. In order to prevent any gluing of the polyester particles, they either need to be sufficiently crystallized, cooled or moved. The movement can be achieved by mechanical movement or by swirling in a gas or liquid stream.

It is principally advantageous to keep the temperature of the polyester particles at the highest possible level in order to keep the energy as low as possible which is required in the subsequent solid state polycondensation step.

An embodiment is especially preferable in which the discharge apparatus concerns a fluid or fluidized bed apparatus with a perforated floor through which gas flows and with one or several product discharge openings.

Solid State Polycondensation

The molecular weight of the polyester granulates which were produced by drop forming is increased by solid state polycondensation to an IV value of higher than 0.65 dl/g.

The solid state polycondensation comprises the steps of crystallization (insofar as this is required after drop forming), preheating, after-condensation reaction, cooling, and providing and preparing the required process gases. Continuous as well as batch processes can be used which occur for example in apparatuses such as fluidized bed, spouted bed or fixed bed reactors as well as reactors with stirring tools or self-moving reactors such as rotary kilns or tumbling driers. The solid state polycondensation can occur under normal pressure, under increased pressure or under vacuum.

For achieving the shortest possible after-condensation time it is known to use the highest possible after-condensation temperatures. Crystallinity is raised to a very high level however, leading to high processing temperatures. In order to obtain sufficiently low processing temperatures it is thus advantageous to ensure that the maximum temperature is at or below 230° C., preferably at or below 225° C., during the solid state polycondensation.

If the after-condensation temperature is reduced, longer after-condensation temperatures are obtained and a too low IV value rising rate in comparison with simultaneously formed crystallinity at the beginning of after-condensation leads the reaction to an asymptotic approximation to a maximum IV value which is still below the desired target IV value. Accordingly, the maximum temperature during the solid state polycondensation should be at or above 205° C., preferably at or above 210° C.

It is also known that the reaction speed in solid state polycondensation is at least partly diffusion-controlled and thus increases with decreasing granulate size.

An optimal after-condensation temperature range is thus obtained for each granulate size in which an IV value of higher than 0.65 dl/g, preferably approximately 0.8 dl/g, can be achieved within an economically viable after-condensation period which is below 40 h, ideally below 30 h. This optimal after-condensation temperature range should lie within the above range for the maximum temperature during the solid state polycondensation.

According to the state of the art it is known that the crystallization speed reaches a maximum value at a temperature below the after-condensation temperature². It is also known that the after-condensation rate decreases with rising crystallinity³. Consequently it is advantageous to rapidly heat up the at least partly crystalline polyester granulates in order to obtain the highest possible rate of increase of IV value during the solid state polycondensation. A respective method has been described in WO 02/068498 whose text shall also be included in this application. The step of preheating to after-condensation temperature shall occur within a period of 1 to 10 minutes, preferably 2 to 8 minutes.
² Qiescent Polymer Crystallization: Modeling and Measurements; T. W. Chan and A. I. Isayev; Polymer Engineering and Science, November 1994; Vol. 34, No. 6

³ Kinetics of thermally induced solid state polycondensation of poly(ethylene terephthalate); T. M. Chang; Polymer Engineering and Science, November 1970; Vol. 10, No. 6

As a result of the initial IV value below 0.4 dl there is a high IV rise in the solid phase, which ensures that degradation products such as vinyl ester or acetaldehyde are removed to the highest possible extent.

Production of Preforms

In order to produce a preform from the after-condensed polyester granulates it is necessary to melt the polyester down at first and then to inject the same into a mold and then cool the same again.

For this purpose the polyester granulate is usually dried at first and processed by means of an injection molding process. The configuration of the injection molding installation (e.g. extruder size and length, screw configuration, trough size and configuration and number of preform per trough) as well as the quality of the produced preform (e.g. preform weight and size) differ depending on the product (application of the finished bottle) and market. It is generally the case that the processing conditions are optimized in the respect that the PET is molten completely (e.g. in order to prevent any clouding of the produced preform) and that the PET is thermally damaged as little as possible, requiring the lowest possible melting temperature (e.g. in order to keep low the quantity of acetaldehyde which is formed in the injection molding process). At the same time, the highest productivity should be achieved, which can be obtained in such a way that the times for the process steps leading to the entire cycle time are kept as short as possible, thus ensuring that also the time needed in order to inject the PET into the mold needs to be kept as short as possible. An optimal processing temperature with which the polyester is injected into the mold is obtained for each combination of a plant configuration, a preform specification and an employed PET. This temperature can be set on the one hand by setting the various heating zones in the injection molding machine and is influenced on the other hand by the mechanical energy absorption via the extruder.

It is understood that the step of cooling of the polyester in the trough should also occur as rapidly as possible after the injection and at a high cooling rate.

The invention allows providing a PET which allows lowering the optimal processing temperature in comparison with the optimal processing temperature (T0) of a conventionally produced PET for a given combination of a plant configuration and preform specification, with the PET in accordance with the invention having a composition (comparable co-monomers and their content) which is comparable with conventionally produced PET.

The invention also allows processing a PET produced in accordance with the invention in such a way that the processing temperature lies 5° C. or more below the optimal processing temperature (T0) of a conventionally produced PET, with the PET in accordance with the invention having a composition (comparable co-monomers and their content) which is comparable with conventionally produced PET.

As a result of the thus reduced processing temperature, the acetaldehyde content in the preform also decreases. The absolute content in acetaldehyde in the preform is obtained through the polyester material specifications, the configuration of the injection molding equipment, the processing conditions in the installation and the specifications of the preform.

An alternative method for the production of preforms can occur through sintering the granulates which are pressed optionally under heating in a mold. The invention also allows in this case to provide a PET which allows lowering the optimal processing temperature in comparison with the optimal processing temperature (T0) of a conventionally produced PET for a given combination of a plant configuration and preform specification, with the PET in accordance with the invention having a composition (comparable co-monomers and their content) which is comparable with conventionally produced PET.

The invention also allows processing a PET produced in accordance with the invention in such a way that the processing temperature lies 5° C. or more below the optimal processing temperature (T0) of a conventionally produced PET, with the PET in accordance with the invention having a composition (comparable co-monomers and their content) which is comparable with conventionally produced PET.

As a result of the thus reduced processing temperature, the acetaldehyde content in the preform also decreases. The absolute content in acetaldehyde in the preform is also obtained through the polyester material specifications, the configuration of the injection molding equipment, the processing conditions in the installation and the specifications of the preform.

The thus produced preform can concern an intermediate form from which the final preform is produced by subsequent re-forming.

The invention allows producing a preform whose acetaldehyde content is reduced in comparison with the acetaldehyde content (AA0) of a conventionally produced preform for a given combination of plant configuration and preform specification, with the preform in accordance with the invention being made of a polyester with material specifications which are comparable with those of a conventionally produced preform.

The invention also allows producing a preform whose acetaldehyde content is 10% or more under the acetaldehyde content (AA0) of a conventionally produced preform, with the preform in accordance with the invention being made of a polyester with material specifications which are comparable with those of a conventionally produced preform.

The reduced acetaldehyde content in the preform in accordance with the invention is achieved without carrying out any additional process steps for the reduction of the acetaldehyde content in the polyester granulate and without adding any additives which can bind acetaldehyde.

Production of Hollow Body

A hollow body (e.g. a bottle) can be produced from the preform by blowing into a larger mold. It can be assumed that in the case of a given preform specification and the associated hollow body specification the acetaldehyde content in the hollow body is proportional to the acetaldehyde content in the preform.

The hollow body can also be produced directly from the polyester granulate, e.g. by extrusion blow molding. The invention allows in this case too providing a PET which allows lowering the optimal processing temperature in comparison with the optimal processing temperature (T0) of a conventionally produced PET for a given combination of a plant configuration and hollow body specification, with the PET in accordance with the invention having a composition (comparable co-monomers and their content) which is comparable with conventionally produced PET.

The invention also allows processing a PET produced in accordance with the invention in such a way that the processing temperature lies 5° C. or more below the optimal processing temperature (T0) of a conventionally produced PET, with the PET in accordance with the invention having a composition (comparable co-monomers and their content) which is comparable with conventionally produced PET.

The thus reduced processing temperature also reduces the acetaldehyde content in the hollow body.

The invention allows producing a hollow body whose acetaldehyde content is reduced in comparison with the acetaldehyde content (AA0) of a conventionally produced hollow body for a given combination of plant configuration and hollow body specification, with the hollow body in accordance with the invention being made of a polyester with material specifications which are comparable with those of a conventionally produced hollow body.

The invention also allows producing a hollow body whose acetaldehyde content is 10% or more under the acetaldehyde content (AA0) of a conventionally produced hollow body, with the hollow body in accordance with the invention being made of a polyester with material specifications which are comparable with those of a conventionally produced hollow body.

The reduced acetaldehyde content in the hollow body in accordance with the invention is achieved without carrying out any additional process steps for the reduction of the acetaldehyde content in the polyester granulate and without adding any additives which can bind acetaldehyde.

### DEFINITIONS

Acetaldehyde content:

The concentration of acetaldehyde in the wall of the hollow body or its preform. The acetaldehyde content of polyester is measured by means of gas phase (“head space”) gas-phase chromatography. The analytical sequence comprises the grinding of the specimen under liquid nitrogen; the weighted-in quantity of 1 g of ground material is placed in a glass vessel with a volume of 29.5 ml and sealed with a septum, a thermal treatment is performed for 10 minutes at 150° C. in order to transfer the acetaldehyde to the gas phase and subsequently a gas phase (“head space”) analysis of the acetaldehyde content is performed. For the last step a portion of the gas phase (=head space) is transferred from the glass vessel via a heated line too a gas-phase chromatograph with a suitable separation column. The quantification of the resulting peak surface is based on a comparison with acetaldehyde measurements of standard calibration solutions.

IV value:

Intrinsic viscosity, measured as a solution viscosity in a solvent mixture phenol/dichlorobenzene (50:50% by weight).

For the measurement, the polyester specimen is dissolved during 10 minutes at 130° in order to obtain a 0.5% solution (0.5 g/dl). The measurement of the relative viscosity (RV) is performed at 25° C. with an Ubbelohde viscometer (according to DIN No. 53728 Part 3, January 1985). The relative viscosity is the quotient of the viscosities of the solution and the pure solvent, which corresponds approximately to the ratio of the respective flow times through the viscometer. The intrinsic viscosity is calculated from the relative viscosity according to the Huggins equation:

(2)

The following applies to the above measuring conditions:
c=0.5 g/dl and the Huggins constant K_{H}=0.35.

1. A method for producing a polyester hollow body or its preform with reduced acetaldehyde content made of drop-shaped, ball-shaped or ball-like polyester granulate with a granulate diameter of less than 2 mm, characterized in that
the molecular weight of the polyester in the production step of the melt phase polymerisation is set to an IV value of 0.15 to 0.4 dl/g;
the melt is transformed by drop shaping into a drop-shaped, ball-shaped or ball-like shape and is thereafter solidified;
the molecular weight of the polyester is increased in the production step of the solid state polycondensation to an IV value of larger than 0.65 dl/g, and
the thus treated polyester material is introduced for forming into a forming means in order to obtain the hollow body or its preform.

2. A method according to claim 1, characterized in that the thus treated polyester material is plasticized at least partly before and/or during its forming.

3. A method according to claim 1 or 2, characterized in that the forming occurs by melting down or injection molding the thus treated polyester material.

4. A method according to claim 1 or 2, characterized in that the forming occurs by extrusion blow molding of the thus treated polyester material.

5. A method according to claim 3 or 4, characterized in that the melting down of the polyester material occurs by means of an extrusion apparatus.

6. A method according to one of the claims 2 to 5, characterized in that the melting down of the polyester material occurs by means of a microwave apparatus.

7. A method according to one of the claims 3 to 6, characterized in that the melting down occurs at a temperature which is 5° C. or more below a temperature T0, with T0 corresponding to the optimal processing temperature at which a similar polyester from a conventional production process can be processed.

8. A method according to claim 1 or 2, characterized in that the forming occurs by sintering of the thus treated polyester material, with the polyester material being introduced into a mold and being formed by sintering into a preform.

9. A method according to one of the preceding claims, characterized in that the polyester concerns a polyethylene terephthalate or a copolymer of polyethylene terephthalate, and the maximum temperature in the production step of solid state polycondensation is at or below 230° C., preferably at or below 225°.

10. A method according to one of the preceding claims, characterized in that the granulate diameter lies in the range of 0.4 to 1.9 mm, preferably in the range of 0.7 to 1.6 mm.

11. A method according to one of the preceding claims, characterized in that the polyester concerns a copolymer of polyethylene terephthalate, with the diol component consisting to more than 94% of ethylene glycol and the dicarboxylic acid component consisting to approximately 100% of terephthalic acid.

12. A method according to one of the preceding claims, characterized in that the polyester concerns a copolymer of polyethylene terephthalate, with the diol component consisting to more than 98% of ethylene glycol.

13. A method according to one of the preceding claims, characterized in that the polyester concerns a copolymer of polyethylene terephthalate, with the dicarboxylic acid component consisting to more than 96% of terephthalic acid.

14. A method according to one of the preceding claims, characterized in that the step of preheating to the after-condensation temperature in solid state polycondensation occurs in a period of 1 to 10 minutes, preferably 2 to 8 minutes.

15. A method according to one of the preceding claims, characterized in that the polyester is removed from the drop forming apparatus after the drop forming with the help of a discharging apparatus, with the discharging apparatus preferably concerning a fluid or fluidized bed with a perforated floor through which gas flows and one or several product discharge openings.

16. A method according to one of the preceding claims, characterized in that a hollow body, especially a bottle, with reduced acetaldehyde content is produced from the preform with reduced acetaldehyde content.

17. A polyester hollow body or its preform, produced according to the method in accordance with one of the preceding claims, characterized in that the acetaldehyde content in the hollow body or its preform is reduced in comparison with the acetaldehyde content (AA0) of a conventionally produced hollow body or its preform.

18. A polyester hollow body or its preform according to claim 17, characterized in that the acetaldehyde content in the hollow body or its preform is reduced by 10% or more in comparison with the acetaldehyde content (AA0) of a conventionally produced hollow body or its preform.

19. A polyester material for producing a polyester hollow body or its preforms with reduced the acetaldehyde content, with the polyester material being present as a drop-shaped, ball-shaped or ball-like polyester granulate with a granulate diameter of less than 2 mm, characterized in that
the molecular weight of the polyester material in a production step of the melt phase polymerization is set to an IV value of 0.15 to 0.4 dl/g;
the melt is transformed by drop shaping into a drop-shaped, ball-shaped or ball-like shape and is thereafter solidified;
the molecular weight of the solidified polyester material is increased in the production step of the solid state polycondensation to an IV value of larger than 0.65 dl/g, and
the thus treated polyester material is introduced for forming into a forming means in order to obtain the polyester hollow body or its preform.

20. A polyester material according to claim 17, characterized in that the melting down occurs at a temperature which is 5° C. or more below a temperature T0, with T0 corresponding to the optimal processing temperature at which a similar polyester from a conventional production process can be processed.

21. A polyester material according to claim 17 or 18, characterized in that the polyester material concerns a polyethylene terephthalate or a copolymer of polyethylene terephthalate, and the maximum temperature in the production step of solid state polycondensation is at or below 230° C., preferably at or below 225°.

22. A polyester material according to one of the claims 17 to 19, characterized in that the granulate diameter lies in the range of 0.4 to 1.9 mm, preferably in the range of 0.7 to 1.6 mm.

23. A method according to one of the claims 17 to 20, characterized in that the step of preheating to the after-condensation temperature in solid state polycondensation occurs in a period of 1 to 10 minutes, preferably 2 to 8 minutes.

24. A polyester hollow body or its preform, produced from a material according to one of the claims 19 to 23, characterized in that the acetaldehyde content in the hollow body or its preform is reduced in comparison with the acetaldehyde content (AA0) of a conventionally produced hollow body or its preform.

25. A polyester hollow body or its preform according to claim 24, characterized in that the acetaldehyde content in the hollow body or its preform is reduced by 10% or more in comparison with the acetaldehyde content (AA0) of a conventionally produced hollow body or its preform.
